(19) United States
(12) Patent Application Publication
(10) Pub. No.: US 2003/0126279 A1
(43) Pub. Date: Jul. 3, 2003

(54) Picture archiving and communication system (PACS) with a distributed architecture

(76) Inventors: Jiani Hu, Farmington Hills, MI (US); Zhanquan He, Windsor (CA); Yang Xuan, Windsor (CA); Wenzheng Feng, Detroit, MI (US)

Correspondence Address: Jiani Hu, 29803 White Hall Dr., Farmington Hills, MI, 48331, US

(21) Appl. No.: 10/026,898

(22) Filed: Dec. 27, 2001

(51) Int. Cl. G06F 15/16

(52) U.S. Cl. 709/233; 709/217

(57) ABSTRACT

A picture archiving and communication system (PACS) includes a plurality of image diagnostic systems, a central archiving system, a coordinator, first network, second network, and means to automatically transfer medical image data generated by a modality to corresponding imaging diagnostic systems first, then the central archiving system.

### CROSS-REFERENCE TO RELATED APPLICATIONS

Not applicable.

### BACKGROUND OF THE INVENTION—FIELD OF INVENTION

This invention relates to the architecture of Picture Archiving and Communication Systems (PACS).

### BACKGROUND OF THE INVENTION—DESCRIPTION OF PRIOR ART

PACS enables radiologists, physicians and patients to view medical images digitally. The advantages of PACS over image hardcopies have become increasingly evident, including the reduction of film costs, the reduction of physical storage space and costs, the reduction of the probability of lost images, increased technologist productivity, and improved satisfaction among referring physicians and patients. However, the financial realities of PACS keep many hospitals from entering the digital era. This, in part, is due to the centralized architecture of existing PACS.

In PACS with a centralized architecture, medical image data acquired from various modalities in a hospital (such as magnetic resonance imaging (MRI) devices, computed tomography (CT) imaging devices, X-ray imaging devices (X-ray), radioisotope (RI) imaging devices, ultrasound (US) imaging devices, endoscope (ES) imaging devices, thermography (TG) imaging devices, and computed radiography (CR) devices), are always first routed to a central server (or several central servers), and then to an image diagnostic system (IDS) for a physician to view, manipulate and interpret the medical image data. Because of this centralized architecture, PACS requires a high-speed network as well as a powerful central server to meet the stringent requirement of fast image transfer required by radiologists in a multi-user environment. Building a network to completely cover a hospital is expensive, particularly when it is a high-speed network. In addition, like any complex system with multiple electronic devices and underlying software, a PACS will occasionally experience system failures. A system failure can cause considerable economic loss both in radiologist and equipment time, and jeopardizing patient care, particularly for urgent cases. A centralized architecture is vulnerable, since a failure in one part of the system can affect the whole. Furthermore, heavy network traffic to and from the central server can become a bottleneck, impeding utility as the number of users or cases increase.

U.S. Pat. No. 5,586,262 disclosed an image data management system to circumvent some of these disadvantages. The system includes multiple image-data-generating sections each having at least one modality for generating diagnostic image data; multiple filing systems associated with and located at each of the sections; a network for interconnecting the modality of each section to the filing system of the respective section; and at least one viewing station connected to the network for viewing a diagnostic image based on image data retrieved from a selected filing system via the network. Although the system improves image data management and network traffic by dividing a pure centralized server into several centralized ones (or a cluster of mini-centralized servers) according to the physical structure and sections of a hospital, it is a modified version of a centralized architecture. Thus, the system still inherits many of disadvantages of a centralized architecture:

(a) medical image data must first go to a filing system, and then to a viewing station under the direction of a physician.

(b) If the filing system fails, the whole section goes down.

(c) It does not take full advantage of a typical radiologist's working environment.

(d) It is a section-oriented, rather than radiologist-oriented, architecture.

### BACKGROUND OF THE INVENTION—CHARACTERISTICS OF RADIOLOGIST'S WORKING ENVIRONMENT

There are three categories of users

Users for PACS can be classified into three categories: radiologist user, general user and special user. Radiologist users are typically radiologists. Satisfying the need of radiologist users is pivotal in the design of any PACS. For example, it is crucial to expeditiously retrieve all necessary information when needed by a radiologist. This is the reason why a high-speed network is required in a centralized architecture. Every effort should also be made to minimize the down-time of PACS since it will waste radiologist time, and is detrimental to timely medical service. General users are non-radiologist physicians who are mainly concerned about the final diagnostic reports. They typically are only allowed to view authorized images and diagnostic reports, and should have a means (such as instant message or email) to communicate with the corresponding radiologist. Special users are typically non-radiologist physicians who need not only the diagnostic report, but also uncompressed medical images for their medical practices (for example, orthopedic surgeons, cardiologists, or neurosurgeons).

There are a limited number of radiologists in each hospital

Typically, a small number of radiologists do all the imaging interpretation in a hospital. For example, typically fewer than two radiologists are reading MRI films simultaneously at a medium-sized hospital with two MRI imagers. The maximum number of radiologists reading MRI films simultaneously in a large hospital with four MRI imagers is approximately four. Other modalities such as CT, ultrasound, etc. compare similarly. The fact that only a handful of radiologists use PACS simultaneously means that a radiologist-oriented architecture (i.e. a distributed architecture in which each radiologist has his/her own image diagnostic system (IDS) to locally store, view and manipulate corresponding medical image data) is practical. One advantage of a distributed architecture is its failure tolerance due to redundant data.

Timely update changes is not crucial for PACS

One of the technical difficulties in a distributed architecture is the timely updating of multiple IDS. Fortunately, timely updating changes is not crucial for PACS for two reasons: (1) original medical image data should never be changed (only the contrast of images), and (2) it takes at least a few minutes (typically a few hours if not more) before a diagnostic report can be returned to a radiologist for final approval. Thus, a PACS with a distributed architecture will offer the advantage of high availability and redundancy while not affecting functionality. In systems where immediately updating transactional changes (such as an inventory or the balance of a money account) is crucial to the business (such as online shipping mall or online stock broker), a centralized architecture is a must. In addition, it is impractical to locally store all data if there are millions of potential users. However, for PACS, because timely updating changes is not crucial and there are only a handful of radiologists working simultaneously in a hospital, a distributed architecture is practical and more suitable than a centralized one.

Number of daily users is limited

The number of daily potential PACS users for each modality is limited, even though the total number for all modalities can be huge. Typically, the number of daily users for each radiologist is about double the number of patients that the radiologist examines: the patient's physician and the patient's specialty physician. Even in the future, when a patient is allowed to view his or her own medical images, the number of daily users for each radiologist will be typically about 3 times the number of patients that the radiologist examines: the patient's physician, the patient's specialty physician and the patient himself. Moreover, the majority of these users need only view diagnostic report and related medical images, not manipulate them.

### BACKGROUND—NEWLY AVAILABLE COMPUTER TECHNOLOGY

Today, currently available personal computers (or personal workstations) make a distributed PACS architecture technically practical: a personal computer is powerful enough to perform all necessary image processing itself, and has enough storage capacity to store months of medical images for a corresponding imaging modality. If history can provide any guide for this trend, personal computers should become even more powerful and less expensive in the future.

### SUMMARY OF THE INVENTION

The primary object of this invention is to provide a distributed architecture for PACS to reduce network traffic during times of peak usage (typically normal working hours), thus permitting the use of a low speed intranet or an existing intranet in a hospital.

It is also an object of the invention to virtually eliminate the downtime due to a failure in a medical diagnostic system or the intranet.

It is also an object of the invention to facilitate future expansion of PACS.

It is a further object of the invention to facilitate integrating PACS with radiology information system (RIS) or hospital information system (HIS) without significantly increasing intranet network traffic.

In accordance with the present invention, PACS will be constructed based on a distributed architecture to take the full advantage of a typical radiologist's working environment and available computer technology. More specifically, medical image data generated by a modality based on signals derived from a patient, as well as past medical records, past diagnostic reports and past medical images for the patient are automatically distributed to the corresponding image diagnostic systems designated to radiologists (or special users) in a manner that minimizes the backbone intranet network traffic in a hospital during peak usage times.

### BRIEF DESCRIPTION OF DRAWING FIGURES

FIG. 1 is a block diagram showing an embodiment of the architecture of PACS according to the present invention.

### TERMINOLOGY & ABBREVIATIONS

MRI—Magnetic Resonance Imaging.

CT—Computed tomography.

CR—Computed radiography.

PACS—Picture Archiving and Communication System.

IDS—Imaging diagnostic system; a IDS comprises a computer, display devices, and software to provide a user with medical imaging data for viewing, interpreting and/or manipulating.

Key-IDS—IDS designated for radiologists or special users.

General-IDS—IDS designated for general users.

### Reference Numerals in Drawing

IDS 101—imaging diagnostic system 101.

IDS 102—imaging diagnostic system 102.

IDS 103—imaging diagnostic system 103.

IDS 111—imaging diagnostic system 111.

IDS 112—imaging diagnostic system 112.

IDS 113—imaging diagnostic system 113.

IDS 114—imaging diagnostic system 114.

IDS 121—imaging diagnostic system 121.

IDS 122—imaging diagnostic system 122.

IDS 123—imaging diagnostic system 123.

IDS 131—imaging diagnostic system 131.

IDS 132—imaging diagnostic system 132.

MRI 201—magnetic resonance imaging device 201.

MRI 202—magnetic resonance imaging device 202.

CT 211—computed tomography imaging device 211.

CT 212—computed tomography imaging device 212.

CT 213—computed tomography imaging device 213.

CR 221—computed radiography imaging device 221.

CR 222—computed radiography imaging device 222.

CR 223—computed radiography imaging device 223.

Local-Intranet 301—intranet connecting all IDS and imaging devices for MRI modality.

Local-Intranet 302—intranet connecting all IDS and imaging devices for CT modality.

Local-Intranet 303—intranet connecting all IDS and imaging devices for CR modality.

Hospital-Intranet 311—intranet covering all area in a hospital.

Central archiving system 401—central archiving system for PACS.

Coordinator 501—coordinator for PACS.

### DETAILED DESCRIPTION OF THE INVENTION

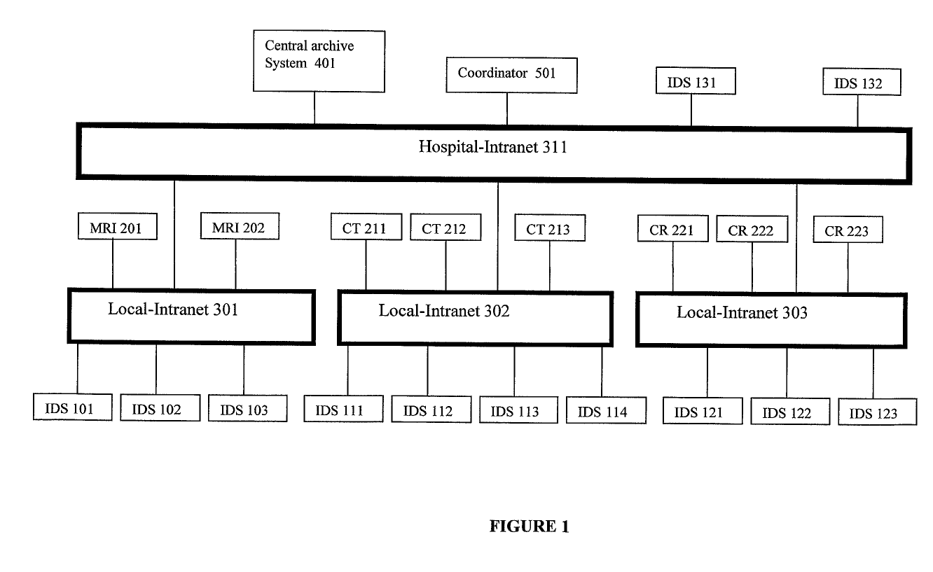

FIG. 1 illustrates an embodiment of the architecture of a PACS according to the present invention. The PACS comprises a plurality of image diagnostic systems (IDS 101, IDS 102, IDS 103, IDS 111, IDS 112, IDS 113, IDS 114, IDS 121, IDS 122, IDS 123, IDS 131 and IDS 132), a central archiving system 401, a coordinator 501, first network (local-intranet), second network (hospital-intranet), and means to automatically transfer medical image data generated by a modality to corresponding IDS for the modality (for example, IDS 101, IDS 102 and IDS 103 for MRI modality; IDS 111, IDS 112, IDS 113 and IDS 114 for CT modality) first, then central archiving system 401. Each IDS provides a user with medical image data for viewing, interpreting, and/or manipulating. The central archiving system 401 provides long-term information storage. The coordinator 501 coordinates the data transfer between IDS attached to a local-intranet, IDS attached to the hospital-intranet, and the central archiving system. A local-intranet for a modality (such as local-intranet 301 for MRI modality) provides a means for transferring medical imaging data generated by an imaging devices (such as MRI 201) to corresponding IDS for the modality (for example, IDS 101, IDS 102, and IDS 103 for MRI modality). The hospital-intranet provides a means for transferring data between different modalities, the coordinator and the central archiving system. According to the present invention, medical image data, once generated by a modality based on signals derived from a patient, will be automatically distributed to all IDS for the modality (for example, it will be IDS 101, IDS 102, and IDS 103 for MRI modality) through the corresponding local-intranet (for example, it will be local-intranet 301 for MRI modality). The associated information for the patient (such as past medical records, past diagnostic reports and past medical image data) is also automatically distributed to all IDS for the modality. But, the data transfer for the associated information is accomplished through the hospital-intranet during light network traffic hours, and is preferably completed in advance.

A patient typically makes his or her appointment for a modality a few days in advance. Thus there should be enough time to complete the transfer of all associated information for the patient at least one day in advance. Similarly, data transferring from IDS attached to a local-intranet (such as IDS 103 for MRI modality) to the central archiving system 401 will take place during nights, weekends or when traffic for hospital-intranet 311 is low. For emergency, urgent care, or inpatient use, the transferring process will start when the examination request (order) is placed and should not take longer than the length of time between request placement and when the patient leaves the examination room, even in the network traffic peak times of a slow network. Furthermore, even in cases where the hospital-intranet 311 crashes, radiologists still have the latest medical images for the patient available on their IDS through a local-intranet, but missing associated information for the patient. This is the most severe failure. In most cases, a hospital-intranet crash should not interrupt radiologist's work since the associated information for patients making their appointments in advance should already be transferred to corresponding IDS long before the crash.

Although two differently labeled intranets (local-intranet and hospital-intranet) are used here to better descript the invention, they can be built with the same technical specifications, such as bandwidth. A hospital-intranet is typically long-distance and complex, covering all area in a hospital complex, while a local-intranet for a modality is short-distance, only connecting medical image devices for a specific modality (such as MRI 201 and MRI 202 for MRI modality) and the corresponding, nearby IDS (such as IDS 101, IDS 102 and IDS 103 for MRI modality). For example, local-intranet 301 could be built by simply connecting each of devices for MRI modality (MRI 201, MRI 202, IDS 101, IDS 102, IDS 103) to aport on a networking switch (such as D-LINK DES-3624, Cisco Catalyst 1924, or 3COM Superstack 3 3300) with a networking cable (such as category 6 or fiber networking cable). Accordingly, a local-intranet is easy to expand and upgrade as needed in this distributed architecture.

One of the concepts in the present invention is to provide key users (e.g., radiologists and special users) with the best possible service while satisfying general users'requirements. Accordingly, an IDS designated for a key user (key-IDS) is preferably attached to its corresponding local-intranets, while all IDS designated for general users (general-IDS) are attached to the hospital-intranet. In accordance with the present invention, all key users have all necessary medical image data fetched automatically to their corresponding IDS even before they begin to use them. This is not the case for general users. A general-IDS only receives medical image data after initiation by an authorized user. The medical image data can be retrieved from one of the key-IDS or from the central archiving system. Because there are multiple key-IDS, coordinator 501 is needed to coordinate the communication between general-IDS, key-IDS and the central archiving system, which includes searching the central archiving system to see if the data is present (which is the typical case), and if not, includes searching key-IDS according to their corresponding modality to retrieve the appropriate information. This coordinator 501 comprises a mixture of hardware and software, and may be separate and/or integrated into other components in the system. As stated previously, a general user is mainly concerned with final diagnostic reports, and original high-quality medical images are not critical for their jobs. Thus, if the hospital-network, to which a general-IDS is attached, is too slow to handle non-compressed image data, there are many available technologies to compress images for fast network transferring. In a simple client/server model, a general-IDS can be a standard personal computer with a web-browser to fetch final diagnostic reports and related medical images from either the central archiving system or a local-IDS installed with a web server. Another advantage of this web-based client/server model is that an authorized user could access PACS outside the hospital through a modem or virtual private network over the Internet.

Typically, the number of IDS are greater than one and less than six for each modality, depending on the number of radiologists working simultaneously for each modality. In other words, the same information needs to be transferred to several IDS once medical image data for a patient are generated by a modality. This should not present any technical difficulty in view of limited number of IDS for each modality and dedicated local-intranet. There are many existing technologies to replicate data, such as various database replication technologies or network automation technologies. A hospital should choose the technology that is most appropriate for its environment. For example, if only two radiologists are working simultaneously for MRI modality: one is a body-radiologist and another is a neuro-radiologist, all brain images should first be sent to the IDS designated to the neuro-radiologist, while non-neuro images should first be sent to the IDS designated to the body-radiologist; then, secondly, the data is distributed to the other IDS. Medical image data locally stored in IDS will be deleted after a predetermined period.

The number of IDS for a modality is, preferably, equal to the number of simultaneously working radiologists for the modality plus one. Although all IDS for a modality can be put together to build a cluster of servers or peer-to-peer server architecture, this extra IDS is preferably configured as the only server for the modality to handle general users' requests, reducing the burden on other IDS being used by the radiologists. In addition, this extra IDS can be used as a backup when one of IDS for the modality failures, or as a teaching machine to teach residents or other physicians.

Most hospitals in US have already built their own intranet. This existing intranet could be used as the hospital-intranet 311 for PACS since PACS in the present invention has a low impact on hospital-intranet traffic during normal working hours, as stated previously. Using an already existing intranet can substantially reduce the cost of building a new hospital-intranet. If all imaging devices for a modality have been already connected to a networking switch in the existing intranet, this can further reduce the cost of building the local-intranet for the modality. An additional advantage of this invention includes the flexibility of building a local-intranet. For example, if installing networking cable is too difficult due to physical restrictions near modality-specific medical devices, a wireless local-intranet or mixture of wire and wireless local-intranet (such as each of all imaging devices for the modality are connected to a networking switch through a networking cable, but all IDS for the modality are connected wirelessly) can be built. Hardware for building a simple wireless local-intranet is fairly inexpensive, and readily available.

### Advantages of the Invention

Unlike PACS with a centralized architecture, where medical image data are transferred to a central server first and then to IDS, PACS in the present invention transfers medical image data generated by a modality to all IDS for the modality through a local-intranet first, and then to the central archiving system when traffic for the hospital-intranet is low. This distributed architecture is based on typical radiologists' working environment in a hospital as stated in the section of characteristics of radiologist's working environment.

From the previous description, a number of advantages of the present invention become evident:

(a) It permits the use of a low speed intranet for the hospital-intranet.

(b) It permits the use of an already existing intranet in most of hospitals in US as the hospital-intranet for PACS.

(c) It eliminates the down-time for radiologists due to a hospital-intranet failure.

(d) It increases the flexibility of PACS to be tailored to the users' specific environments or needs.

(e) It divides a large workload (the sum workload for all patients in all modalities) handled by a centralized server into small workloads handled by many individual IDS.

(f) It restricts the majority of network traffic within each local-intranet during network traffic peak hours.

(g) It increases the scalability of the system.

Obviously, numerous modifications and variations of the present invention are possible in light of the above description. It is therefore to be understood that within the scope of the claims, the invention may be practiced otherwise than as specifically described herein.

### Sequence Listing

Not applicable.

We claim:

1. A picture archiving and communication system for managing medical images in a hospital, comprising:
(a) a plurality of image diagnostic systems, each providing an authorized user with medical image data generated by a modality based on signals derived from a patient,
(b) a central archiving system, for long-term storing said medical image data,
(c) a coordinator, for coordinating data transfer among said image diagnostic systems and said central archiving system.
(d) first network, providing the means for transferring said medical image data of said patient to the image diagnostic systems for said modality,
(e) second network, providing the means for transferring said medical image data to said central archiving system from said first network, to said image diagnostic systems from said central archiving system, and
(f) means for said image diagnostic systems for said modality automatically receiving said medical image data once generated by said modality, and said central archiving system automatically receiving said medical image data when traffic in said second network is low.
Whereby said second network traffic can be reduced during network peak hours.

2. The picture archiving and communication system of claim 1 wherein said second network is an already existing network for said hospital.
whereby the need for building said second network for said picture archiving and communication system is eliminated.

3. The picture archiving and communication system of claim 1 wherein said first network is a wired network, a wireless network, or a mixture of the two.
Whereby difficulties of physically installing networking cable for said first network could be alleviated.
